(19) United States
(12) Patent Application Publication
(10) Pub. No.: US 2006/0231785 A1
(43) Pub. Date: Oct. 19, 2006

(54) Valve for controlling a fluid

(76) Inventors: Waldemar Hans, Bamberg (DE); Ian Faye, Stuttgart (DE); Frank Brenner, Remseck (DE); Frank Miller, Ilsfeld (DE); Martin Maier, Moeglingen (DE); Guenther Bantleon, Leonberg (DE); Thanh-Hung Nguyen-Schaefer, Asperg (DE); Thomas Hebner, Ditzingen (DE); Kai Kroeger, Stuttgart (DE)

Correspondence Address: KENYON & KENYON LLP, ONE BROADWAY, NEW YORK, NY, 10004, US

(21) Appl. No.: 10/540,900

(22) PCT Filed: Dec. 9, 2003
(86) PCT No.: PCT/DE03/04039

§ 371 Date: Apr. 24, 2006

(30) Foreign Application Priority Data
Dec. 27, 2002 (DE) 102 61 610.8

(51) Int. Cl. F16K 31/02

(52) U.S. Cl. 251/129.21

(57) ABSTRACT

A valve for controlling a fluid, in particular for controlling a gas, is described, encompassing a valve housing an actuation unit for an at least locally tubular valve armature which is guided axially displaceably and is equipped with a valve closure member by which a fluid flow between an inflow side and an outlet side is controllable and which coacts with a valve seat. The valve armature comprises a guidance collar in a region remote from the valve closure member, and is equipped with a second guidance in a region offset with respect to the guidance collar.

### FIELD OF THE INVENTION

The invention proceeds from a valve for controlling a fluid, in particular for controlling a gas.

### BACKGROUND INFORMATION

A valve of this kind is known from practical use and is usable, for example, as a gas delivery valve in a spark-ignited engine, operated with natural gas (NG), of a motor vehicle. This valve designed for controlling a gas encompasses a valve housing in which a valve armature is axially displaceably guided. The valve armature, whose displacement can be triggered by way of an electromagnetic actuation unit, is equipped with a valve closure member which coacts with a valve seat and by which a fluid flow between an inflow side and an outlet side of the valve is controllable.

In known gas valves of the kind described, the problem exists that when an oil-free gas is used, material wear occurs in the region of the valve armature and the valve seat because of the absence of lubrication, and that the valve armature can tilt and thus become jammed on the valve body, which in turn results in premature failure of the valve's functionality.

### SUMMARY OF THE INVENTION

The valve according to the present invention for controlling a fluid, in particular for controlling a gas in which valve the valve armature comprises a guidance collar in a region remote from the valve closure member, and is equipped with a second guidance means in a region offset with respect to the guidance collar, has the advantage that tilt-proof guidance of the valve armature is guaranteed, so that the risk of a failure of the valve as a result of tilting of the valve armature is minimized.

The valve according to the present invention is usable in particular as a gas valve in stationary facilities, such as energy generators; in motor vehicles in conjunction with a gas drive system or a fuel cell; and in a so-called APU (auxiliary power unit) of a motor vehicle.

In a preferred embodiment of the valve according to the present invention, the second guidance means is constituted by a leaf spring. The leaf spring is preferably retained between the valve armature and the valve housing, so that its plane is oriented at right angles to the axis of the valve armature. The leaf spring permits a motion of the armature parallel to the armature axis, and prevents a motion of the valve armature in the radial direction.

A particular stable attachment of the leaf spring exists if the leaf spring is clamped and/or welded in between the valve closure member and a tubular region of the valve armature.

In order to rule out flow loss in the region of the leaf spring, the leaf spring can also be disposed upstream from radial outlet orifices of the valve armature that are usually present.

If the leaf spring is disposed downstream from the flow orifices, it is useful if it is of annular configuration and is equipped with flow passages for the fluid flow.

The guidance collar of the valve armature can moreover be coated with a dry lubricant, for example MoS₂, anti-friction coatings, or carbon layers.

In an alternative embodiment of the valve according to the present invention, the second guidance means is constituted by the valve closure member. The valve closure member, which can be produced in one piece with the valve armature or also as a separate component that is joined to the valve armature, is then contiguous in the radial direction with a guidance surface that is preferably constituted by the valve housing.

In a special embodiment of the valve according to the present invention, the valve armature is guided in a deep drawn valve bushing that is a constituent of the valve housing. In this case the valve closure member, preferably produced in one piece with the valve armature, then has substantially the same diameter as, or a somewhat smaller diameter than, the guidance collar of the valve armature.

To allow a high-pressure gas space, disposed between the valve seat and the outlet orifices and delimited radially by the valve housing, to be made large, the valve armature can have a constriction in the region of the radial outlet orifices. This results in high efficiency for the valve, since upon opening of the valve closure member, the gas contained in that high-pressure gas space flows out first.

In order to prevent material damage to the valve closure member or valve armature, a throttling element can be disposed downstream from the valve seat, so that a throttling of the gas flowing through the valve occurs remotely from the valve closure member. The maximum pressure drop in the valve according to the present invention thus takes place at the throttling element.

In an advantageous embodiment, the valve seat of the valve according to the present invention has a flow-through cross section that is at least two to three times as large as the flow-through cross section of the throttling element. The mass flow through the valve is dependent, in this context, on the pressure after the valve seat and the diameter of the throttling element. In addition, the throttling element preferably has a length that is selected to be on the order of its diameter.

In order to minimize the pressure drop between the inflow side of the valve and the valve seat, it is useful for the outlet orifices implemented on the valve armature to have, together, a flow-through cross section that likewise corresponds to at least a multiple of the flow-through cross section.

The gas valve according to the present invention is preferably designed so that the Mach number (Ma) at the exit of the throttling element is equal to 1 (sonic flow). A compression pulse then takes place directly after the throttling element in the damping tube.

In comparison thereto, existing gas valves usually operate at high Mach numbers that can be in the range of up to Mach 3, especially in the region of the exit opening of the valves. The Mach number is defined, in the context of a compressible flow, as the ratio between the speed of the gas and the corresponding speed of sound in the gas medium. Because of the valve geometry and the exit boundary condition of the environment, a stream of gas in a gas valve is greatly decelerated, i.e. a reduction in Mach number occurs. Because the pressure increase is proportional to the square of the Mach number, a compression pulse is thereby created which can cause material damage to the valve body and undesirable noise at the valve exit.

To prevent the compression pulse from being transferred to the valve closure member, it is useful if a damping tube that is preferably located after the throttling element has a diameter that corresponds to at least three times the throttling element diameter.

In order to keep the Mach number of the gas flow at the exit of the damping tube well below 1, and to bring about a substantial reduction in noise generation, it is useful if the damping tube has a length that corresponds to at least ten times the throttling element diameter.

### BRIEF DESCRIPTION OF THE DRAWINGS

FIG. 1 shows a longitudinal section through a first embodiment of the valve according to the present invention.

FIG. 2 shows an enlarged depiction of an outflow side of the valve according to FIG. 1.

FIG. 3 shows a guide of a valve closure member of the valve according to FIG. 1.

FIG. 4 shows a leaf spring of the valve according to FIG. 1.

FIG. 5 shows a portion of a longitudinal section through a second embodiment of a valve configured according to the present invention.

FIG. 6 shows a depiction, corresponding to FIG. 5, of a longitudinal section through a third embodiment of a valve according to the present invention.

FIG. 7 shows a depiction, corresponding to FIG. 5, of a longitudinal section through a fourth embodiment of a valve according to the present invention.

FIG. 8 shows a longitudinal section through a fifth embodiment of a valve according to the present invention that has a guidance bushing.

### DETAILED DESCRIPTION

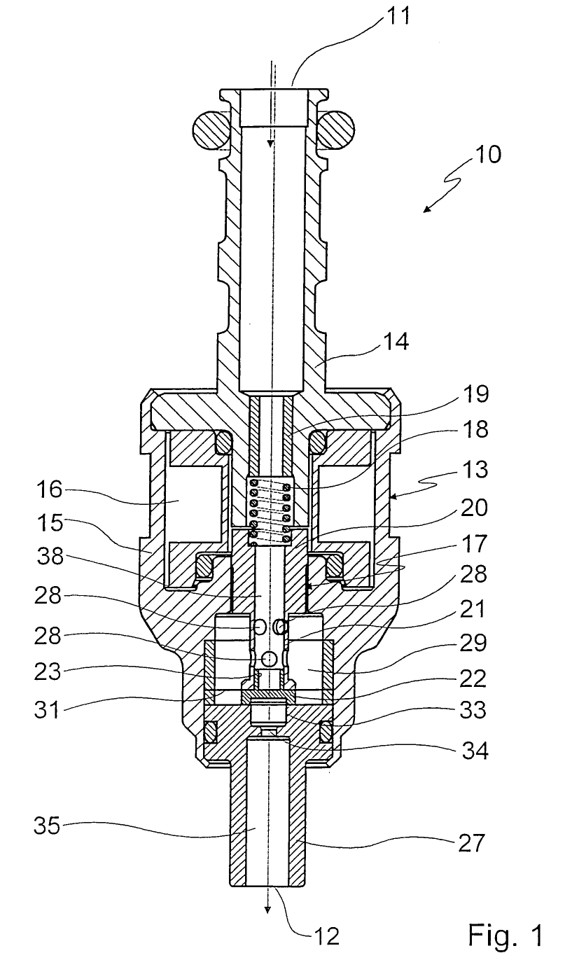

FIGS. 1 through 4 depict a gas valve 10 that is designed for use in a fuel cell or in a gas engine and that serves to regulate a flow of hydrogen or of natural gas (NG) from an inflow side 11 to an outlet side 12.

Gas valve 10 encompasses a multi-part housing 13 having a substantially tubular insert 14, on which inflow side 11 is configured and which is inserted axially, with a flange-like shoulder having an outside diameter enlargement, into a substantially hollow-cylindrical central valve body 15. Configured in central valve body 15 is a space 16 for an electromagnetic actuation unit that coacts with a valve armature 17 which is braced via a helical spring 18 against a sleeve 19 inserted into an inner orifice of insert 14.

Valve armature 17 encompasses a region 20 of increased outside diameter as well as a region 21 of reduced outside diameter embodied in the manner of a constriction, adjacent to which at the end face is a valve closure member 22 that is inserted, via a tubular extension 23, into an axial longitudinal orifice 38 of region 21 of reduced outside diameter of valve armature 17.

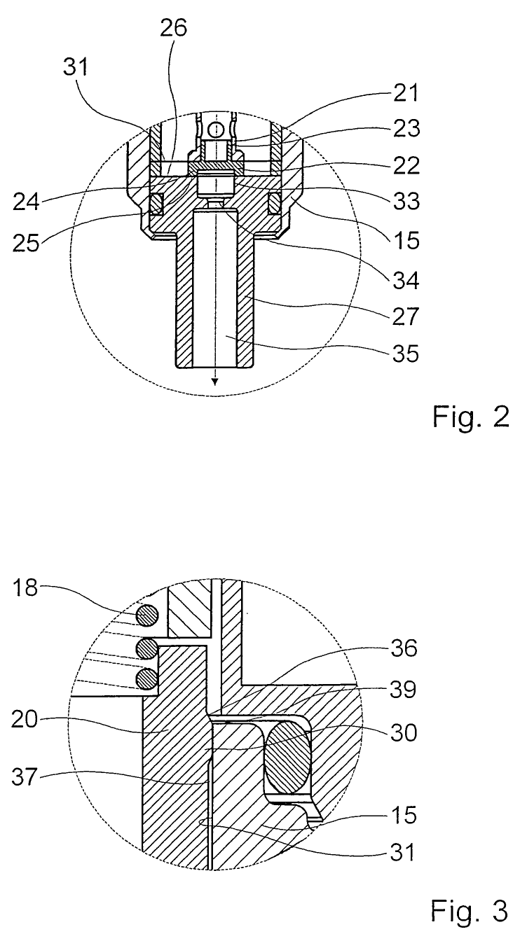

As is evident in particular from FIG. 2, valve closure member 22 has at its exposed end face a sealing collar 24 that coacts with a valve seat 25 embodied as a flat seat and is constituted by an elastomer sealing ring.

Flat seat 25 is embodied on an end surface 26 of a so-called damping tube 27 that is also inserted into valve body 15 and constitutes outlet side 12.

Valve armature 17 has, in its region 21 of reduced outside diameter, radial outlet orifices 28 that are distributed in the circumferential direction in two rows axially offset from one another and that connect longitudinal orifice 38 of valve armature 17, which orifice is in communication with inflow side 11, to a high-pressure gas space 29 that is radially delimited on one side by valve armature 17 and on the other side by valve housing 13. In the axial direction, high-pressure gas space 29 is adjacent to end surface 26 of damping tube 27.

Outlet orifices 28 are each relatively short in terms of their longitudinal extension, so that only a small pressure drop prior to valve seat 25 occurs because of them.

In its region 20 of increased outside diameter that is disposed axially remotely from valve closure member 22, valve armature 17 is axially displaceably guided by a guidance collar 30 in an axial orifice 31 of valve body 15, as is evident in particular from FIG. 3. Guidance collar 30 represents an enlargement, constituted by an edge or bevel 36, of the outside diameter of valve armature 17, so that the latter is adjacent to an edge 39 of valve body 15 that forms the inside diameter. This prevents the entry of dirt particles, upon opening of valve closure member 22, into an annular gap 37 constituted between the outside diameter of region 20 of increased outside diameter of valve armature 17 and the inside diameter of valve body 15.

To minimize wear, valve armature 17 is moreover treated with an anti-friction coating at least in the region of guidance collar 30.

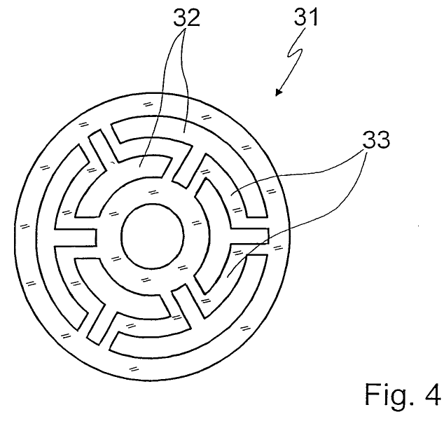

In the present case valve armature 17 is guided, in its region 21 of reduced outside diameter that is axially offset with respect to guidance collar 30, by a leaf spring 31 that is depicted in more detail in FIG. 4. Leaf spring 31 is of annular configuration and is joined on one side to valve housing 13 and on the other side to valve armature 17, specifically in such a way that leaf spring 31 is clamped between region 21 of reduced outside diameter and valve closure member 22. Valve closure member 22 and region 21 of reduced outside diameter of valve armature 17 are here immovably joined to one another by a welded join.

The leaf spring, which in the embodiment shown is manufactured by laser cutting and has an axial thickness of approximately 1 mm, furthermore has several struts 33 that delimit gas flow-through openings 32 for the gas to be controlled. Leaf spring 31 prevents motion of valve armature 17 in the radial direction, valve armature 17 being mounted on leaf spring 31 in such a way that it operates in wear-free fashion in the mounting region.

Damping tube 27 moreover has, downstream from valve seat 25, a cylindrical space 33 that is axially connected, via a throttling element 34 of reduced diameter, to a damping space or expansion space 35 embodied as an axial longitudinal orifice of damping tube 27. Because of throttling element 34 and cylindrical space 33 that precedes it, pressure pulses are displaced in such a way that they occur downstream from throttling element 34 and dissipate in expansion space 35. Damage to valve closure member 22 by pressure pulses can thereby be minimized.

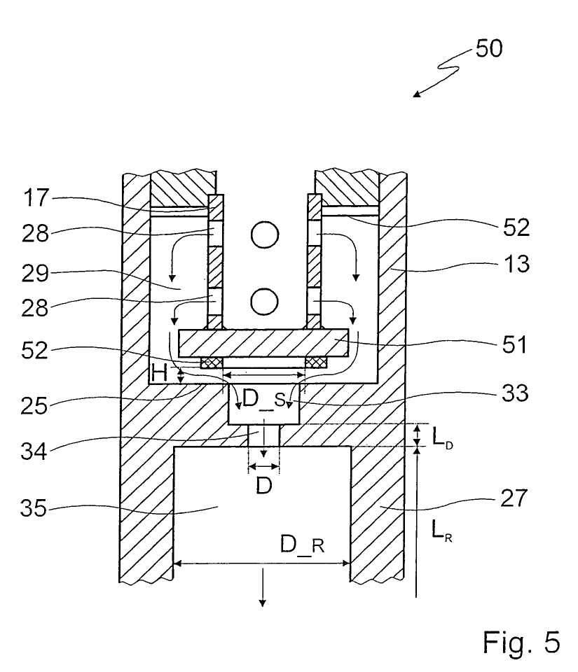

FIG. 5 depicts a second embodiment of a gas valve 50 according to the present invention for use in a fuel cell or a gas engine. Gas valve 50 corresponds largely to the one according to FIG. 1, and for that reason components that correspond to one another are assigned the same reference numbers.

Gas valve 50 encompasses a valve housing 13 in which a valve armature 17 of substantially tubular configuration is axially displaceably guided. Valve armature 17 encompasses, at its end face toward the valve seat, a valve plate 51 serving as valve closure member, which in the present case is spot-welded to the tubular region of valve armature 17 and coacts, via an elastomer sealing ring 52, with a valve seat 25 embodied as a flat seat, thus controlling a gas flow between a pressure space 29 and a cylindrical space or throttling space 33.

Corresponding to the embodiment shown in FIG. 1, valve armature 17 has radial outlet orifices 28 that once again are distributed in the circumferential direction in two rows axially offset from one another and ensure a gas flow between the inner space of valve armature 17 and pressure space 29. It is also conceivable to provide only one row of outlet orifices, or more than two rows of outlet orifices.

In a region facing away from valve closure member 51, valve armature 17 is guided in valve housing 13 by, for example, a guidance collar that is not depicted here but corresponds to the embodiment shown in FIG. 1.

Valve armature 17 has, as a second guidance means that is offset in the axial direction with respect to the guidance collar, a leaf spring 51 that is retained between valve armature 17 and valve housing 13 and is located upstream from radial outlet orifices 28 of valve armature 17.

As in the embodiment shown in FIG. 1, there is disposed downstream from throttling space 33 a throttling element 34 that leads to a damping space 35 of a damping tube 27. As a result of throttling element 34, the maximum pressure drop in gas valve 50 is shifted to a point located downstream from valve seat 25 and valve closure member 51.

Gas valve 50 is designed in such a way that there is present at valve seat 25 a minimal flow-through cross section having a seat diameter D_S which corresponds to six times the flow-through cross section of throttling element 34 of diameter D. Throttling element 34 has a length L_D that corresponds approximately to its diameter D.

Outlet orifices 28 likewise have, in total, a flow-through cross section that corresponds to at least six times the throttling element cross section.

Located after throttling element 34 is a damping tube 27 which has an inside diameter D_R that corresponds to at least three times the throttling element diameter D, and a length L_R that corresponds to at least ten times the throttling element diameter D.

Valve closure member 51 or valve armature 17 has, in the embodiment shown, a linear stroke H of approximately 0.3 to 0.4 mm.

Valve housing 13 and damping tube 27 are depicted in FIG. 5 as one piece. In practice, however, it may in some cases be useful to configure damping tube 27 as a separate component that is joined to valve housing 13.

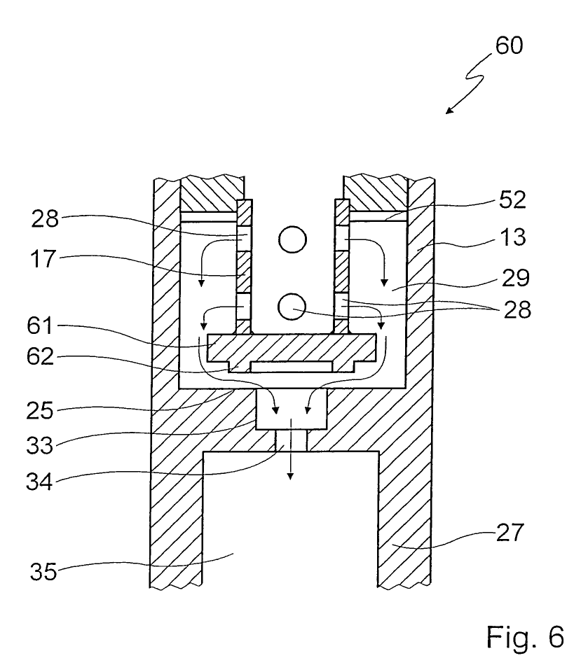

FIG. 6 depicts a further embodiment of a valve 60, which differs from the one shown in FIG. 5 in that it has as the valve closure member a valve plate 61 that has a metal sealing ring 62 produced integrally with valve plate 61. The use of a metal sealing ring 62 reduces wear in the sealing region of gas valve 60. Changes in linear stroke that might be caused by an expansion of an elastomer sealing material during valve opening also cannot occur. Valve 60 can also be used as a gasoline valve.

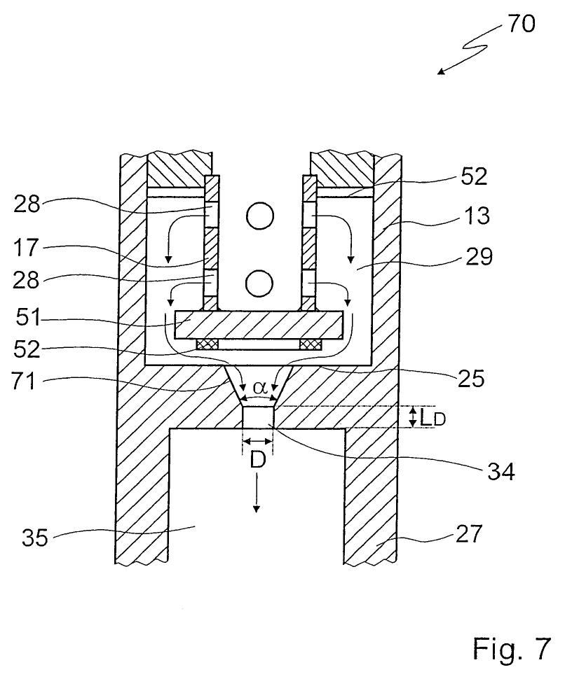

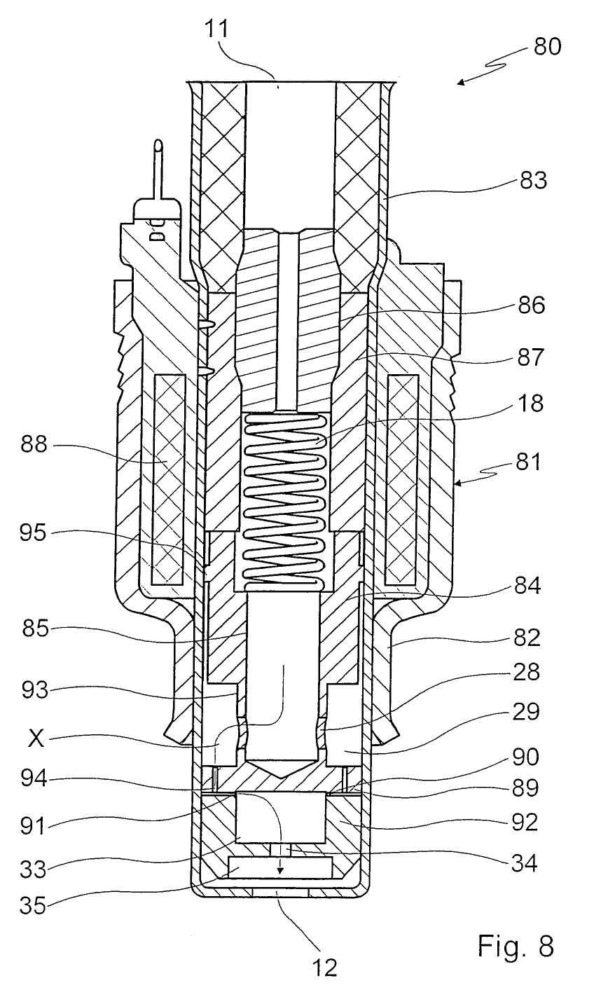

FIG. 7 depicts a gas valve 70 that corresponds substantially to the gas valve shown in FIG. 5, but differs from the latter in that it has a throttling space 71 which is configured substantially conically, in which context the cone angle [alpha] can be between 60 degrees and 120 degrees. The conical configuration of throttling space 71 can result in better flow as compared with a cylindrical throttling space, since so-called “dead zones” are reduced. FIG. 8 depicts a further embodiment of a gas valve 80 according to the present invention that is designed for use in a gas engine.

Gas valve 80 encompasses a housing 81 having a substantially hollow-cylindrical valve body 82 and a deep drawn guidance bushing 83, disposed in valve body 82, for reception of a valve armature 84. Valve armature 84 is equipped with an axially oriented blind orifice 85 and is braced via a helical spring 18 against a plug 86 which is inserted into a tubular piece 87 that is incorporated immovably into guidance bushing 83. Blind orifice 85 is in communication with an inflow side 11 of gas valve 80.

Valve armature 84, which is axially displaceable by way of an electromagnetic actuation unit 88 surrounding guidance bushing 83, has a valve closure member 89 that coacts via a sealing ring 90 with a valve seat 91 embodied as a flat seat. Sealing ring 90 of valve closure member 89 can be made of metal or also of an elastomer.

Valve seat 91 is embodied at one end surface of a tubular piece 92 that is inserted into guidance bushing 83 and serves as a valve plate. Embodied in valve plate 92 is a cylindrical orifice 33 that represents a throttling space preceding a throttling element 34, which in turn leads to a dissipation space 35. The diameter of throttling element 34 determines the maximum volumetric flow in gas valve 80.

Valve closure member 89 is, in the present case, produced in one piece with valve armature 84, so that valve closure member 89 does not need to be welded on.

Valve armature 84 furthermore has a constriction or diameter contraction 93, which opens up a high-pressure space 29 and in the region of which are disposed radial outlet orifices 28 that connect axial blind orifice 85 of valve armature 84 to high-pressure gas space 29.

In order to connect high-pressure gas space 29 to throttling space 33 when valve closure member 89 is open, the valve closure member has axial orifices 94 distributed in the circumferential direction. The gas flow in valve 80 is depicted by an arrow X.

Valve armature 84 is guided in such a way that it has, in its region facing toward valve closure member 89, a guidance collar 95 that is in contact against the inner wall of guidance bushing 83.

In order to prevent tilting of valve armature 84, valve armature 84 is furthermore guided in guidance bushing 83 by valve closure member 89, valve closure member 89 having a slightly smaller diameter than guidance collar 95; this facilitates the manufacture of guidance surfaces in guidance bushing 83.

The guidance surfaces on guidance collar 95, on valve closure member 89, and/or on guidance bushing 83 can be coated with a suitable anti-friction coating in order to improve the run-in behavior of valve armature 84. The anti-friction coating also contributes to consistent frictional properties over the service life of gas valve 80.

1.-14. (canceled)

15. A valve for controlling a fluid, comprising:
a valve housing;
an at least locally tubular valve armature;
a valve seat;
an actuation unit for the valve armature, wherein:
the valve armature is guided axially displaceably and includes a valve closure member by which a fluid flow between an inflow side and an outlet side is controllable and which coacts with the valve seat,
the valve armature includes a guidance collar in a region remote from the valve closure member, and
the valve armature is equipped with a second guidance arrangement in a region offset with respect to the guidance collar.

16. The valve as recited in claim 15, wherein the second guidance includes a leaf spring.

17. The valve as recited in claim 16, wherein the leaf spring is retained between the valve closure member and the valve housing.

18. The valve as recited in claim 16, wherein the leaf spring is disposed upstream from radial outlet orifices of the valve armature.

19. The valve as recited in claim 16, wherein the leaf spring is of annular configuration and has flow passages for the fluid flow.

20. The valve as recited in claim 15, wherein the second guidance arrangement includes the valve closure member.

21. The valve as recited in claim 15, further comprising:
a deep drawn valve bushing included in the valve housing and in which the valve armature is guided.

22. The valve as recited in claim 15, wherein the valve armature has a constriction in a region of radial outlet orifices.

23. The valve as recited in claim 15, further comprising:
a throttling element that coacts with a preceding throttling space and that is disposed downstream from the valve seat.

24. The valve as recited in claim 23, wherein the valve seat has a flow-through cross section that corresponds to at least two to three times a flow-through cross section of the throttling element.

25. The valve as recited in claim 23, wherein a flow-through cross section of an outlet orifice corresponds to at least a multiple of a flow-through cross section of the throttling element.

26. The valve as recited in claim 23, further comprising:
a damping tube arranged downstream from the throttling element.

27. The valve as recited in claim 26, wherein the damping tube has an inside diameter that corresponds to at least three times a diameter of the throttling element.

28. The valve as recited in claim 26, wherein the damping tube has a length that corresponds to at least ten times a diameter of the throttling element.

29. The valve as recited in claim 15, wherein the fluid includes a gas.
